(19) United States
(12) Patent Application Publication
(10) Pub. No.: US 2008/0218096 A1
(43) Pub. Date: Sep. 11, 2008

(54) Parasitic Capacitance Compensation System and Method

(75) Inventor: David Fang, Naperville, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,504

(22) PCT Filed: Jul. 6, 2006
(86) PCT No.: PCT/IB2006/052292

§ 371 Date: Jan. 3, 2008

Related U.S. Application Data
(60) Provisional application No. 60/697,254, filed on Jul. 7, 2005.

(51) Int. Cl. H05B 37/02

(52) U.S. Cl. 315/224

(57) ABSTRACT

A parasitic capacitance compensation system and method, with a parasitic capacitance compensation circuit for an electronic ballast including a phase detector 60 generating a phase difference signal 62 in response to a lamp voltage signal 48 and an output current signal 50, a filter 64 generating a dimming correction signal 66 in response to the phase difference signal 62, and an adjuster 68 generating an adjusted dim signal 44 in response to a dim signal 54 and the dimming correction signal 66. A parasitic capacitance compensation method for an electronic ballast includes measuring phase difference between a lamp voltage and an output current, determining an amount of parasitic current from the phase difference, and increasing the output current by the amount of the parasitic current.

This invention relates generally to lamp dimming control, and more specifically to a system and method for lamp dimming to compensate for parasitic capacitance.

Electronic ballasts for fluorescent lamps have become sophisticated and are widely used in a variety of applications. One application that has presented problems is dimmable electronic ballasts. For instance, at low dimming levels variable frequency electronic ballasts operate at a higher frequencies, such as 70 to 90 kHz, and lamp resistance increases: lamp current can be less than 10 mA. A substantial portion of the current from the electronic ballast flows through the parasitic capacitance between the wires connecting the lamp to the ballast and not through the lamp. With dimming level limited to 5 percent of full output, the design limit for wire length is typically 6 feet.

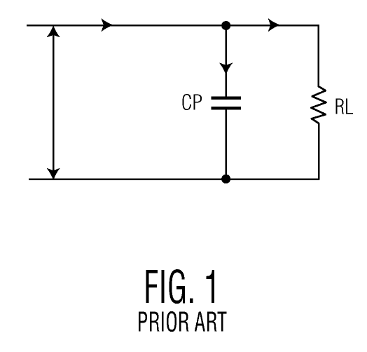

To provide the demanded dimming level with longer wires, the electronic ballast must produce more current to make up for the current lost to the parasitic capacitance. FIG. 1 is a schematic diagram of an equivalent circuit for a lamp and wiring. A lamp voltage Vlamp is generated by an electronic ballast producing an output current Iout. The output current Iout is split between lamp current Ilamp passing through a lamp having lamp resistance RL and parasitic current Icap passing across the parasitic capacitance CP between the wires attaching the electronic ballast to the lamp. In one example, the parasitic capacitance between two AWG18 wires connecting to one filament of a lamp and two AWG18 wires connecting to the other filament of a lamp is about 13 pF per foot. For a 10 foot length of wire, the parasitic capacitance CP is 130 pF. For an electronic ballast operating at 70 kHz and providing a Vlamp of about 395 Volts at room temperature, the parasitic current Icap is 2π·f·CP·Vlamp, or 22.6 mA. For a T5 35 W lamp operating at a 2.5% dimming level, lamp current Ilamp is about 4.5 mA, so the parasitic current Icap is greater than the lamp current Ilamp. Thus, to keep the lamp current Ilamp at about 4.5 mA, the electronic ballast must deliver the square root of the sum of the squares of lamp current Ilamp and parasitic current Icap, or 23 mA.

It would be desirable to provide a parasitic capacitance compensation system and method that overcomes the above disadvantages.

One aspect of the invention provides a parasitic capacitance compensation circuit for an electronic ballast including a phase detector generating a phase difference signal in response to a lamp voltage signal and an output current signal, a filter generating a dimming correction signal in response to the phase difference signal, and an adjuster generating an adjusted dim signal in response to a dim signal and the dimming correction signal.

Another aspect of the invention provides a parasitic capacitance compensation method for an electronic ballast including measuring phase difference between a lamp voltage and an output current, determining an amount of parasitic current from the phase difference, and increasing the output current by the amount of the parasitic current.

Another aspect of the invention provides a parasitic capacitance compensation system including means for measuring phase difference between a lamp voltage and an output current, means for determining an amount of parasitic current from the phase difference, and means for increasing the output current by the amount of the parasitic current.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1 is a schematic diagram of an equivalent circuit for a lamp and wiring;

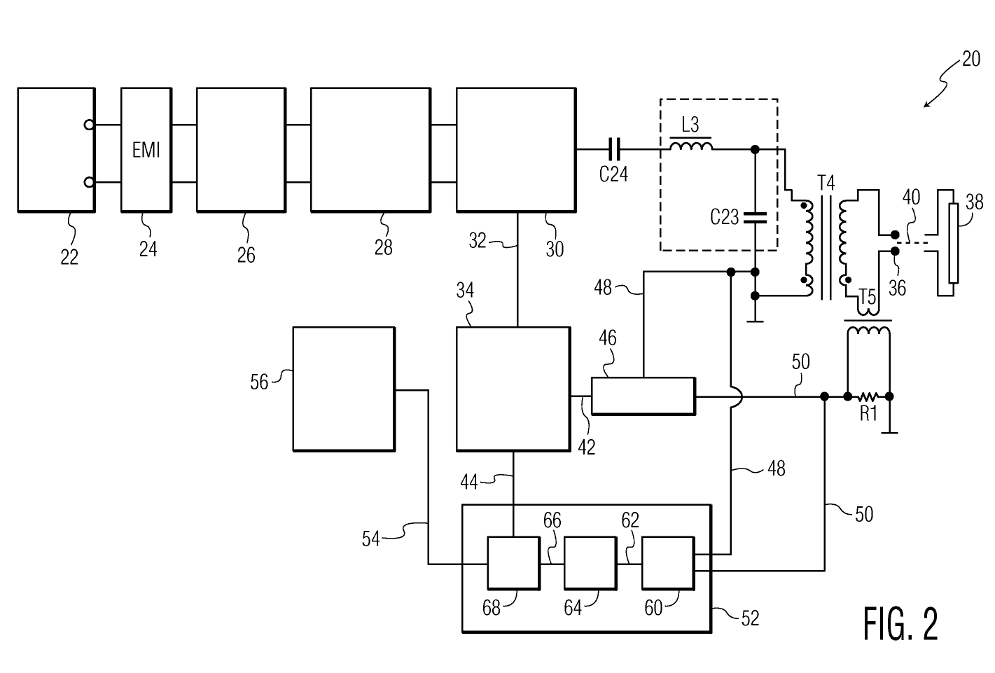

FIG. 2 is a block diagram of a lighting system with parasitic capacitance compensation made in accordance with the present invention; and

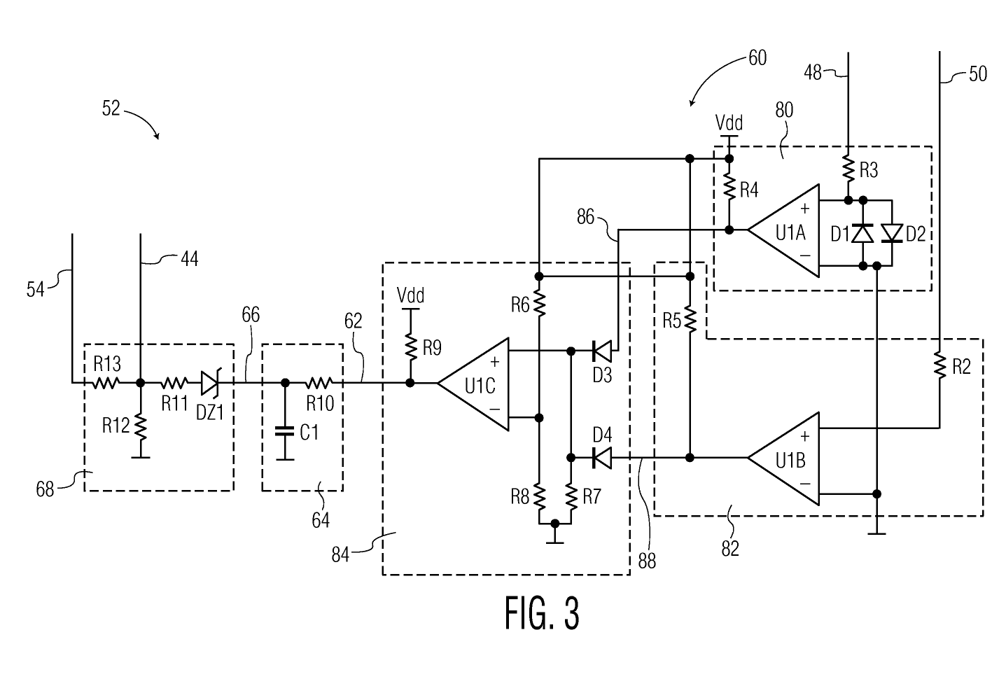

FIGS. 3 & 4 are a schematic diagram and voltage traces, respectively, of a parasitic capacitance compensation circuit for a dimming electronic ballast made in accordance with the present invention.

FIG. 2 is a block diagram of a lighting system with parasitic capacitance compensation made in accordance with the present invention. A parasitic compensation circuit measures the phase difference between the lamp voltage and ballast output current, determines the amount of parasitic current from the phase difference, and increases the output current by the amount of the parasitic current to allow for parasitic capacitance. This assures that the lamp current is maintained at the dimming level requested by the dim signal, even for dimming levels of a few percent and long lamp wires connecting the ballast and lamp.

Electronic ballast 20 receives mains power, such as 120 Volt or 277 Volt power line power, at power source 22. EMI filter 24, operably connected to rectifier 26, removes high frequency harmonics generated by preconditioner 28 and inverter 30. The rectifier 26 rectifies the filtered AC voltage from the EMI filter 24 and provides a DC voltage to the preconditioner 28, which boosts and smoothes the DC voltage, and corrects the input power factor to greater than 0.9. Inverter 30 converts the smoothed DC voltage to a high frequency square wave voltage in response to drive signal 32 from drive controller 34. The high frequency square wave voltage is provided to the resonant tank circuit, which includes inductor L3 and capacitor C23, through blocking capacitor C24. Output transformer T4 connected across capacitor C23 delivers power at ballast output 36, which is operably connected to lamp 38 through lamp wire 40.

The drive controller 34 is responsive to feedback signal 42 and adjusted dim signal 44 to generate the drive signal 32. Feedback circuit 46 generates the feedback signal 42 in response to lamp voltage signal 48 from a center tap of the output transformer T4 and output current signal 50 from current transformer T5 (at resistor R1) operably connected to the ballast output 36. Parasitic compensation circuit 52 generates the adjusted dim signal 44 in response to dim signal 54 from dim interface 56, the lamp voltage signal 48, and the output current signal 50. The dim signal 54 reflects the lamp level for the lamp 38 desired by the user.

The parasitic compensation circuit 52 includes a phase detector 60 generating a phase difference signal 62 in response to the lamp voltage signal 48 and the output current signal 50, a filter 64 generating a dimming correction signal 66 in response to the phase difference signal 62, and an adjuster 68 generating the adjusted dim signal 44 in response to the dim signal 54 and the dimming correction signal 66. The parasitic compensation circuit 52 allows dimming with long lamp wires 40, such as 1 to 30 feet, at lower dimming levels, such as 0.5 to 20 percent of full output. In one example, a 3 percent dimming level can be achieved with a 20 foot wire length. In another example, a 1 percent dimming level can be achieved with a 6 foot wire length. In yet another example, a 5 percent dimming level can be achieved with a 30 foot wire length. Those skilled in the art will appreciate that use of the parasitic compensation circuit 52 is not limited to the exemplary electronic ballast described above, but that the parasitic compensation circuit 52 can be used with virtually any ballast where dimming is desired. In one embodiment, the parasitic compensation circuit 52 is incorporated in the drive controller 34 as an analog circuit, digital circuit, or microprocessor program.

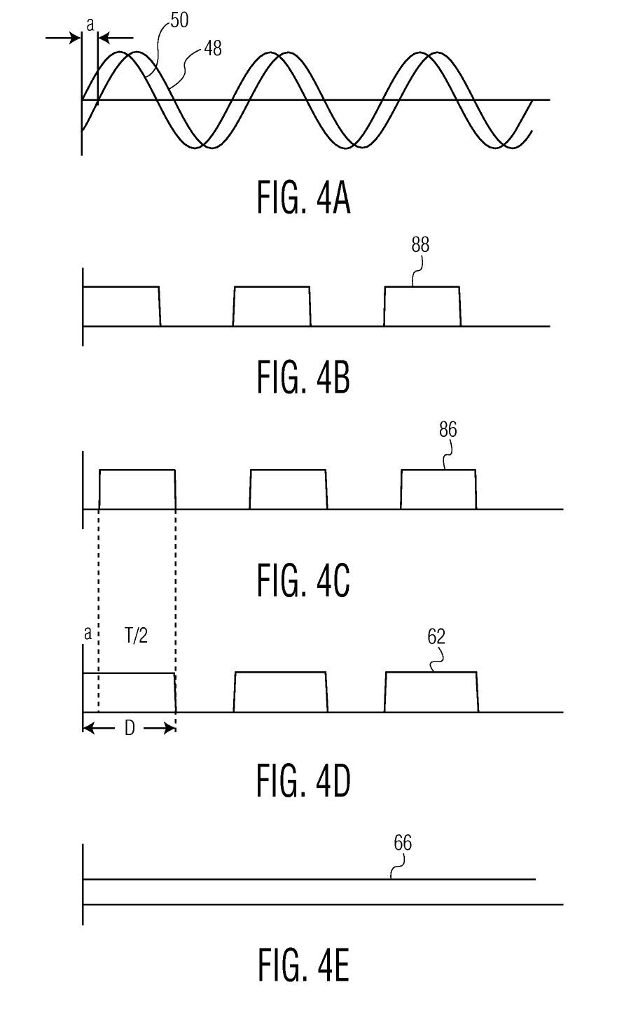

FIG. 3, in which like elements share like reference numbers with FIG. 2, is a schematic diagram of a parasitic capacitance compensation circuit for a dimming electronic ballast made in accordance with the present invention. The parasitic compensation circuit 52 measures the phase difference between the lamp voltage signal 48 and the output current signal 50, determines a dimming correction from the phase difference, and adjusts the dim signal 54 by the dimming correction to generate the adjusted dim signal 44. FIG. 4 illustrates voltage traces for the parasitic capacitance compensation circuit of FIG. 3.

Referring to FIG. 3, the parasitic compensation circuit 52 includes the phase detector 60, the filter 64, and the adjuster 68. The phase detector 60 includes a voltage zero crossing comparator 80, a current zero crossing comparator 82, and a logical circuit 84. The phase detector 60 converts the lamp voltage to a square wave voltage, converts the output current to a square wave current, and logically compounds the square wave voltage and the square wave current to generate the phase difference by ORing or NORing the square wave voltage and the square wave current

The voltage zero crossing comparator 80 includes resistor R3 providing the lamp voltage signal 48 to the positive input of comparator U1A, a ground connection to the negative input of the comparator U1A, an optional input protection circuit including diodes D1 and D2 between the positive and negative input of the comparator U1A, and resistor R4 connecting the output of the comparator U1A to reference voltage Vdd. The voltage zero crossing comparator 80 generates a square wave voltage signal 86 with a 50 percent duty cycle at the output of the comparator U1A in response to the lamp voltage signal 48.

The current zero crossing comparator 82 includes resistor R2 providing the output current signal 50 to the positive input of comparator U1B, a ground connection to the negative input of the comparator U1B, and resistor R5 connecting the output of the comparator U1B to reference voltage Vdd. In one embodiment, the current zero crossing comparator 82 can include an optional input protection circuit between the positive and negative input of the comparator U1B similar to that used in the voltage zero crossing comparator 80 with diodes D1 and D2. The current zero crossing comparator 82 generates a square wave current signal 88 with a 50 percent duty cycle at the output of the comparator U1B in response to the output current signal 50.

The logical circuit 84 ORs the square wave voltage signal 86 and the square wave current signal 88 to generate the phase difference signal 62. The width of the phase difference signal 62 includes a variable portion due to the phase difference and a constant portion from the 50 percent duty cycle, which is independent of the phase difference. The logical circuit 84 includes diodes D3, D4, resistors R6, R7, R8, comparator U1C, and resistor R9. The diodes D3, D4 provide the square wave voltage signal 86 and the square wave current signal 88 to the positive input of the comparator U1C which is also connected to ground through resistor R7. The negative input of the comparator U1C is connected to the voltage divider including resistors R6, R8 connected between reference voltage Vdd and ground. The output of the comparator U1C is connected to reference voltage Vdd through resistor R9. Those skilled in the art will appreciate that the logical circuit 84 is not limited to the exemplary OR circuit and that other logic combinations, such as a NOR circuit can be used. When the logical circuit 84 is a NOR circuit that NORs the square wave voltage signal 86 and the square wave current signal 88 to generate the phase difference signal 62, the width of the phase difference signal 62 is due to the phase difference alone.

The filter 64 includes resistor R10 receiving the phase difference signal 62 from the logical circuit 84 and capacitor C1 connected to ground. The filter 64 converts the square wave phase difference signal 62 to the DC dimming correction signal 66. The magnitude of the DC dimming correction signal 66 includes a variable DC portion from the phase difference portion of the square wave phase difference signal 62 and a constant DC portion equal to Vdd/2 from the 50 percent duty cycle portion of the square wave phase difference signal 62.

The adjuster 68 adds the dimming correction signal 66 to the dim signal 54 to generate the adjusted dim signal 44. The adjuster 68 includes resistors R11, R12, R13 connected at a common junction providing the adjusted dim signal 44. Resistor R11 receives the dimming correction signal 66, resistor R12 is connected to ground, and resistor R13 receives the dim signal 54. The adjuster 68 also includes Zener diode DZ1 connected between the filter 64 and resistor R11 as a zero phase shift correction to remove the constant DC portion Vdd/2 from the DC dimming correction signal 66. The constant DC portion is introduced when the logical circuit 84 is an OR circuit. Those skilled in the art will appreciate that the Zener diode DZ1 used as a zero phase shift correction is optional in other embodiments. In one example, when the logical circuit 84 is a NOR circuit the DC dimming correction signal 66 does not include a constant DC portion from the 50 percent duty cycle portion of the square wave phase difference signal 62, so no zero phase shift correction is required and the Zener diode DZ1 can be omitted. In another example, the drive controller 34 can be designed to compensate for the 50 percent duty cycle portion of the adjusted dim signal 44 that carries over into the adjusted dim signal 44 from the DC dimming correction signal 66 when the Zener diode DZ1 is omitted.

Referring to FIG. 1, the equivalent impedance for the lamp and wiring Vlamp/Iout is equal to RL/(1+j·W·RL·CP), where RL is lamp resistance, j is the imaginary unit, W is operating frequency, Vlamp is lamp voltage, and CP is parasitic capacitance. The phase difference a between Vlamp and Iout is equal to −A tan(W·RL·CP). The phase difference a is typically between 0 and 80 degrees. FIG. 4A illustrates the waveforms of the lamp voltage signal 48 and the output current signal 50 with phase difference a. In operation, the logical circuit of the parasitic compensation circuit receives the square wave current signal 88 and the square wave voltage signal 86 as illustrated in FIGS. 4B & 4C, respectively. FIG. 4D illustrates the phase difference signal 62, which has pulse width D equal to T/2+A tan(W·RL·CP)/W, where T is the cycle period. The T/2 portion of pulse width D is from the 50 percent duty cycle that arises when the logical circuit 84 is an OR circuit and the A tan(W·RL·CP)/W portion of pulse width D is from the phase difference a. FIG. 4D illustrates the dimming correction signal 66 at the Zener diode DZ1 and has a square wave voltage equal to Vdd·(½+A tan(W·RL·CP)/(2·π)), where Vdd is the reference voltage.

Those skilled in the art will appreciate that a number of variations in the components and circuitry described above can be used to measure phase difference between a lamp voltage and an output current, determine an amount of parasitic current from the phase difference, and increase the output current by the amount of the parasitic current. In one embodiment, the phase detector 60 generating a phase difference signal 62 in response to the lamp voltage signal 48 and the output current signal 50 can be a phase locked loop integrated circuit. In another embodiment, the logical circuit 84 is a NOR circuit and the width of the phase difference signal 62 is due to the phase difference alone. No Zener diode DZ1 is required in the adjuster 68 because the phase difference signal 62 does not include a portion from the 50 percent duty cycle that is carried over into the dimming correction signal 66. In another embodiment, the phase detector 60 can be a zero crossing detection circuit, detecting the time difference between the lamp voltage signal 48 crossing zero and the output current signal 50 crossing zero.

The zero crossing detection circuit measures phase difference between a lamp voltage and an output current by detecting a current zero crossing time for the output current and detecting a voltage zero crossing time for the lamp voltage, then determining the phase difference from the time difference between the current zero crossing time and the voltage zero crossing time. The current zero crossing time can be determined by a current zero crossing detector monitoring the output current signal 50. The voltage zero crossing time can be determined by a voltage zero crossing detector monitoring the lamp voltage signal 48. A calculator can be used to generate the phase difference signal 62 from the time difference between the current zero crossing time and the voltage zero crossing time. In one embodiment, the current zero crossing detector, voltage zero crossing detector, and calculator can be implemented on an integrated circuit, such as a microprocessor. Those skilled in the art will appreciate that the current zero crossing time and voltage zero crossing time can be detected at different points in the respective output current signal 50 and lamp voltage signal 48 as desired for a particular application. In one example, the current zero crossing time is detected as the output current signal 50 crosses zero from negative to positive and the voltage zero crossing time is detected as the lamp voltage signal 48 crosses zero from negative to positive. In another example, the current zero crossing time is detected as the output current signal 50 crosses zero from negative to positive and the voltage zero crossing time is detected as the lamp voltage signal 48 crosses zero from positive to negative. The phase difference a can be measured over a portion of a cycle, one cycle, or a number of cycles as desired.

While the embodiments of the invention disclosed herein are presently considered to be preferred, various changes and modifications can be made without departing from the scope of the invention. Those skilled in the art will appreciate that the embodiments described for FIGS. 2 & 3 are exemplary and that alternative circuits, including analog and/or digital circuits, can be used as desired for particular applications. The scope of the invention is indicated in the appended claims, and all changes that come within the meaning and range of equivalents are intended to be embraced therein.

1. A parasitic capacitance compensation circuit for an electronic ballast comprising:
a phase detector 60 generating a phase difference signal 62 in response to a lamp voltage signal 48 and an output current signal 50;
a filter 64 generating a dimming correction signal 66 in response to the phase difference signal 62; and
an adjuster 68 generating an adjusted dim signal 44 in response to a dim signal 54 and the dimming correction signal 66.

2. The circuit of claim 1 wherein the phase detector 60 comprises:
a voltage zero crossing comparator 80 generating a square wave voltage signal 86 in response to the lamp voltage signal 48;
a current zero crossing comparator 82 generating a square wave current signal 88 in response to the output current signal 50; and
a logical circuit 84 generating the phase difference signal 62 in response to the lamp voltage signal 48 and the output current signal 50.

3. The circuit of claim 2 further comprising an input protection circuit operably connected to the voltage zero crossing comparator 80.

4. The circuit of claim 2 further comprising an input protection circuit operably connected to the current zero crossing comparator 82.

5. The circuit of claim 2 wherein the logical circuit 84 is selected from the group consisting of an OR circuit and a NOR circuit.

6. The circuit of claim 1 wherein the phase detector 60 comprises:
a current zero crossing detector detecting a current zero crossing time in response to the output current signal 50;
a voltage zero crossing detector detecting a voltage zero crossing time in response to the lamp voltage signal 48; and
a calculator generating the phase difference signal 62 from time difference between the current zero crossing time and the voltage zero crossing time.

7. The circuit of claim 1 wherein the adjuster 68 has a zero phase shift correction.

8. The circuit of claim 1 wherein the dim signal 54 is between 0.5 and 20 percent of full output.

9. The circuit of claim 1 further comprising a lamp wire 40 connecting the ballast to a lamp 38, wherein the lamp wire 40 is between 1 and 30 feet long.

10. A parasitic capacitance compensation method for an electronic ballast comprising:
measuring phase difference between a lamp voltage and an output current;
determining an amount of parasitic current from the phase difference; and
increasing the output current by the amount of the parasitic current.

11. The method of claim 10 wherein the measuring comprises:
converting the lamp voltage to a square wave voltage;
converting the output current to a square wave current; and
logically compounding the square wave voltage and the square wave current to generate the phase difference.

12. The method of claim 11 wherein the logically compounding is selected from the group consisting of ORing and NORing.

13. The method of claim 10 wherein the measuring comprises:
detecting a current zero crossing time for the output current;
detecting a voltage zero crossing time for the lamp voltage; and
determining the phase difference from time between the current zero crossing time and the voltage zero crossing time.

14. The method of claim 10 wherein:
the determining comprises determining a dimming correction from the phase difference; and
the increasing comprises adjusting a dim signal by the dimming correction.

15. The method of claim 14 further comprising correcting the dimming correction at zero phase shift.

16. A parasitic capacitance compensation system comprising:
means for measuring phase difference between a lamp voltage and an output current;
means for determining an amount of parasitic current from the phase difference; and
means for increasing the output current by the amount of the parasitic current.

17. The system of claim 16 wherein the means for measuring comprises:
means for converting the lamp voltage to a square wave voltage;
means for converting the output current to a square wave current; and
means for logically compounding the square wave voltage and the square wave current to generate the phase difference.

18. The system of claim 17 wherein the means for logically compounding is selected from the group consisting of means for ORing the square wave voltage and the square wave current and means for NORing the square wave voltage and the square wave current.

19. The system of claim 16 wherein the means for measuring comprises:
means for detecting a current zero crossing time for the output current;
means for detecting a voltage zero crossing time for the lamp voltage; and
means for determining the phase difference from time between the current zero crossing time and the voltage zero crossing time.

20. The system of claim 16 wherein:
the means for determining comprises means for determining a dimming correction from the phase difference; and
the means for increasing comprises means for adjusting a dim signal by the dimming correction.
